(19) United States
(12) Patent Application Publication
(10) Pub. No.: US 2018/0281661 A1
(43) Pub. Date: Oct. 4, 2018

(54) LOAD TENSION ASSEMBLY

(71) Applicant: USA Products Group LTD, Lodi, CA (US)

(72) Inventor: Manuel Lopez, Lodi, CA (US)

(73) Assignee: USA Products Group LTD, Lodi, CA (US)

(21) Appl. No.: 15/479,041

(22) Filed: Apr. 4, 2017

(51) Int. Cl. B60P 7/08; B65H 18/12

(52) U.S. Cl. CPC B60P 7/0853; B65H 18/12

(57) ABSTRACT

A load tension assembly comprising a main body including a rotatable hub having a slot to accept a strap and a single gear connected to the rotatable hub; and a handle assembly having a drive pawl biased by a first spring to engage the single gear of the main body, and a trigger release connected to the drive pawl, the entire handle assembly positioned lateral to the rotatable hub, is disclosed herein.

### BACKGROUND

The present disclosure relates generally to a tension assembly, and more particularly to a load tension assembly having, among other things, a handle assembly having an ergonomic grip and trigger release for a relatively more efficient, versatile, and easier to use load tension assembly.

Modern load tension assemblies used to secure cargo are usually of two types, specifically, cam buckle or ratching style technologies.

A typical ratchet assembly includes a rotatable hub with a plurality of outwardly-extending teeth for engagement with a spring-loaded pawl. A terminal end of the ratchet assembly is anchored to a first point. As the spool is rotated in one direction, a line, such as a flat webbing attached to a second point is wrapped around the hub to apply a tension to the line. As the hub rotates, the pawl engages the teeth to prevent the hub from rotating in the opposite direction due to the tension from the line.

Cam buckle assembly technology differs in that the cam buckle is depressed to open the teeth of the assembly while manual tension in applied to pull the webbing through the cam buckle. The webbing is typically held in place by a back pressure on the closed teeth of the cam buckle.

Although load tension assemblies are well known, the complicated assembly and working mechanism of known handles and release mechanism make tensioning a load with known load tension assemblies a cumbersome and inefficient task.

As such, it would be desirable to provide an improved load tension assembly having, among other things, a handle assembly having an ergonomic grip and trigger release for a relatively more efficient, versatile, and easier to use load tension assembly.

### SUMMARY

For purposes of summarizing the disclosure, exemplary concepts have been described herein. It is to be understood that not necessarily all such concepts may be achieved in accordance with any particular embodiment. Thus, for example, those skilled in the art will recognize that embodiments may be carried out in a manner that achieves or optimizes one concept as taught herein without necessarily achieving other concepts as may be taught or suggested herein.

In one embodiment, a load tension assembly comprises a main body including a rotatable hub having a slot to accept a strap; a single gear connected to the rotatable hub; and a handle assembly having a drive pawl biased by a first spring to engage the single gear, and a trigger release connected to the drive pawl with the entire handle assembly positioned lateral to the rotatable hub.

In another embodiment, a load tension assembly comprises a main body including a rotatable hub; a single gear connected to the rotatable hub; and a handle assembly connected to the main body and positioned lateral to the rotatable hub, the handle assembly having a drive pawl engaged with the single gear, and a trigger release connected to the drive pawl.

These and other embodiments will become apparent to those skilled in the art from the following detailed description of the various embodiments having reference to the attached figures, the disclosure not being limited to any particular embodiment.

### BRIEF DESCRIPTION OF THE DRAWINGS

FIG. 1 shows a perspective view of a known load tension assembly.

FIG. 2 shows a perspective view of another known load tension assembly.

FIG. 3 shows a perspective view of a load tension assembly with a strap attached in accordance with one embodiment disclosed herein.

FIG. 4 shows a perspective view of the load tension assembly of FIG. 3 with the strap removed in accordance with one embodiment disclosed herein.

FIG. 5 shows the load tension assembly of FIG. 3 in one example environment in accordance with one embodiment disclosed herein.

FIG. 6 shows a cut-away view of a handle assembly of the load tension assembly of FIG. 3 in accordance with one embodiment dislosed herein.

FIG. 7 shows an exploded view of the load tension assembly of FIG. 3 in accordance with one embodiment disclosed herein.

FIGS. 8 through 10 show the load tension assembly of FIG. 3 in various positions of a load tension cycle in accordance with one embodiment disclosed herein.

### DETAILED DESCRIPTION

Exemplary embodiments will now be described with references to the accompanying figures, wherein like reference numbers refer to like elements throughout. The terminology used in the description presented herein in not intended to be interpreted in any limited or restrictive manner simply because it is being utilized in conjunction with a detailed description of certain embodiments. Furthermore, various embodiments (whether or not specifically described herein) may include novel features, no single one of which is solely responsible for its desirable attributes or which is essential to practicing any of the embodiments herein described.

The present disclosure relates generally to a load tension assembly, and more particularly to a tension assembly having, among other things, an ergonomic handle and trigger release for a relatively more efficient, versatile, and easier to use load tension assembly.

As used herein, the term “hub” is intended to include a spindle, a spool, a sheave, or a similar type article(s) that is configured or may be adapted to permit rotation of the hub to facilitate tensioning of a “strap” used for the purpose of applying tension to secure a “load”.

As used herein, the term “strap” is intended to include a line, a rope (round synthetic, natural fiber, metal), a cable, a cord, a flat line (webbing), an anchor line or tensioning line, or a similar type of article(s) that may be adapted to be used with the load tension assembly disclosed herein for the purpose of applying tension, herein referred to as a “load tension”, to secure a “load”.

As used herein, the term“load” or “cargo” is intended to include any item or items that are generally secured to prevent movement of the item(s) while in a static position, or while being moved or transport from one position to another position. The load tension assembly described herein provides, among other things, an ergonomic handle and release trigger for a relatively more efficient, versatile, and easier to use load tension assembly.

Various parts, elements, components, etc, of the load tension assmbly disclosed herein may be constructed from metal, plastic, composite, or other suitable material or combination thereof for providing a rigid and sturdy structure to facilitate tensioning of a line for the purpose of securing a load.

The actual size and dimension of any and all of the various parts, elements, components, etc., of the load tension assembly may vary depending on various factors including, among other things, intending application or usage of the tension assembly, as well as the size of the load to be secured or prevented from moving while in a static position, or while being moved or transport from one position to another position.

Connection(s) between the various parts, elements, components, etc., of the load tension assembly may be accomplished using a variety of methods or processes. As such, the connections, whether integral and created via bending, or form molding, for example, or connected via bonding, hardware (nuts, bolts, washers, etc.), welding, or similar techniques, are well known in the art and omitted for simplicity.

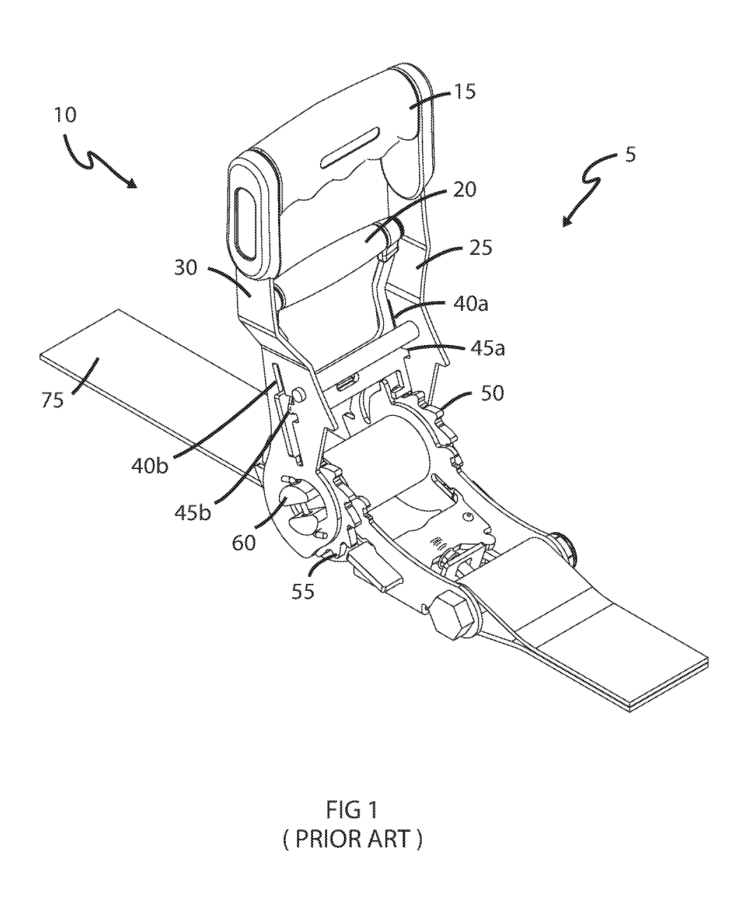

FIG. 1 shows a known ratchet type load tension assembly 5 for applying a tension to a load. The known load tension assembly 5 includes a handle assembly 10, an upper rod 15, and an upper drive pawl 20 disposed between opposite sides 25, 30 of the handle assembly 10. The sides 25, 30 of the handle assembly 10 each include a respective slot 40a, 40b for receiving a corresponding flange 45a, 45b positioned on opposite sides of the upper drive pawl 20 to permit the flanges 45a, 45b to slidably move within the slots 40a, 40b to either engage or disengage the flanges 45a, 45b of the upper drive pawl 20 from gears 50, 55 positioned on opposite sides of a hub 60. In this regard, in contrast to the inventive subject matter disclosed herein, the upper rod 15 and the upper drive pawl 20 of the handle assembly 5 are positioned above the hub 60 and strap 75. As the handle assembly 5 is rotated about the hub 60, a strap 75 is wrapped around the hub 60 to gradually apply tension to the strap 75 disposed about a load. In order to disengage the flanges 45a, 45b from the corresponding gears 50, 55 the user typically places the palm of one hand on the upper rod 15 and uses multiple of fingers to grasp and pull the upper drive pawl 20 in a direction away from the hub 60. In this regard, disengagement of the flanges 45a, 45b of upper drive pawl 20 from the gears 50, 55 is accomplished.

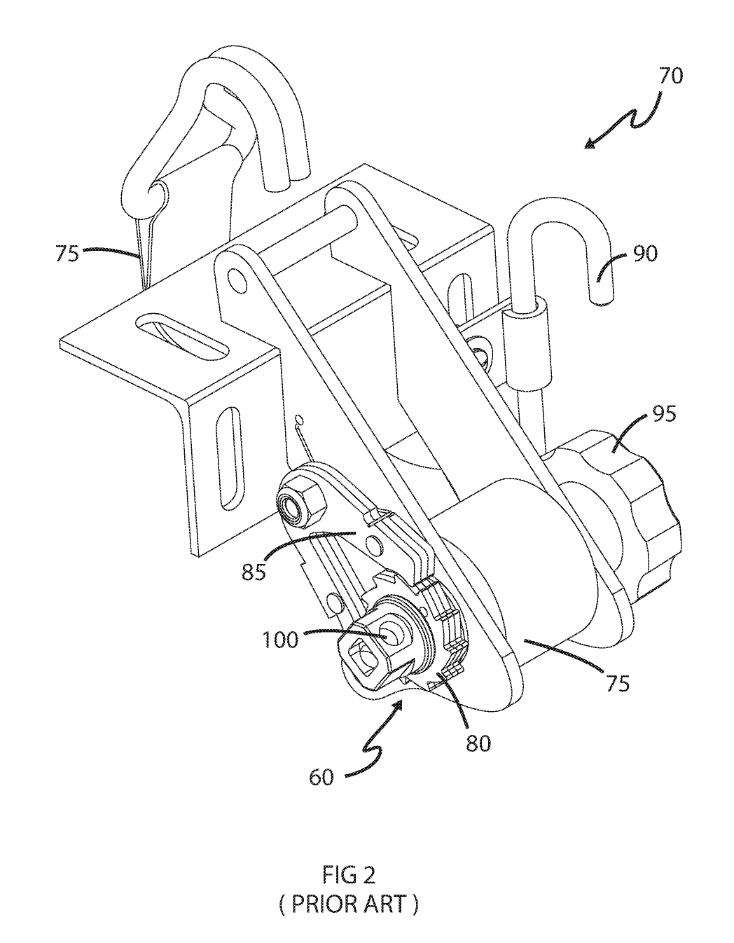

FIG. 2 shows a perspective view of another known load tension assembly 70. In this regard, the basic concept of tensioning a load with the known load tension assembly 70 of FIG. 2 and the known load tension assembly 15 of FIG. 1 is essentially the same as a strap 75 secured at one end is wrapped around a hub 60 to gradually apply tension to the strap 75 disposed about a load. The known load tension assembly 70 includes a hub 60 having a gear, and a pawl 85 to engage and disengage the teeth of the gear 80. Engagement of the pawl 85 with the gear prohibits rotation of the gear 80 while disengagement of the gear 80 permits rotation of the gear 80. Engagement of the pawl 85 with the gear 80 is accomplished due a force such as a spring or gravity on the pawl 85. Disengagement of the pawl 85 is accomplished by using a bar 90 placed in a hole 100 or the use of a knob 95 to apply force and rotate the hub 60 in a direction away from the pawl 85 to remove tension from the pawl 85. With tension removed from the pawl 85, the pawl 85 is manually lifted away from the gear 80, and the hub 60 is free to rotate to remove tension from the load.

In contrast to the known ratchet type load tension assembly, the novel load tension assembly disclosed herein provides a unique and relatively less complicated structural configuration resulting in ease of operation.

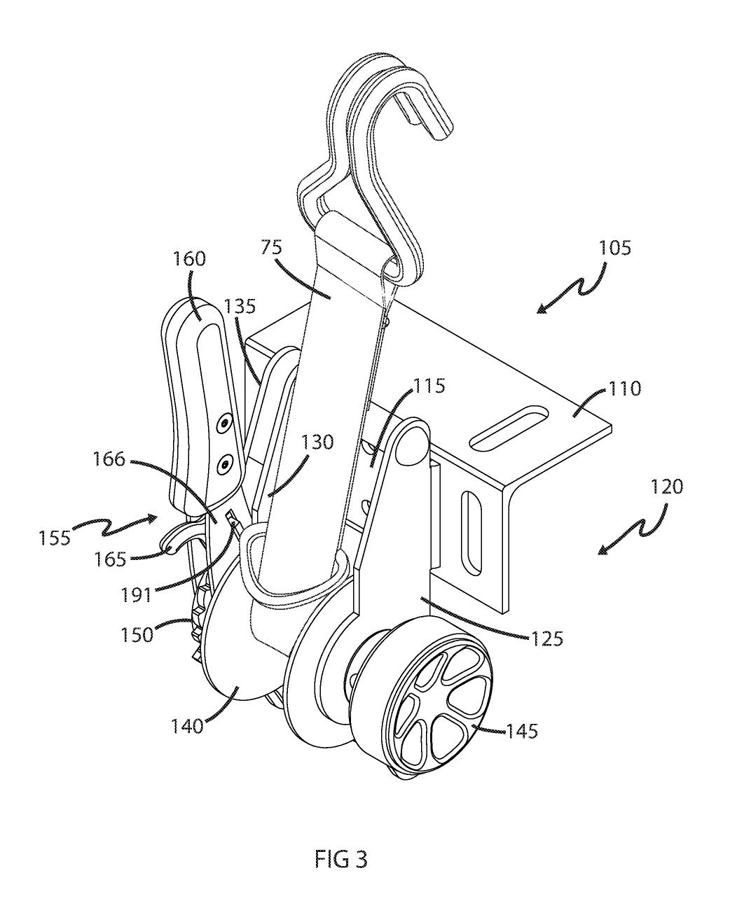

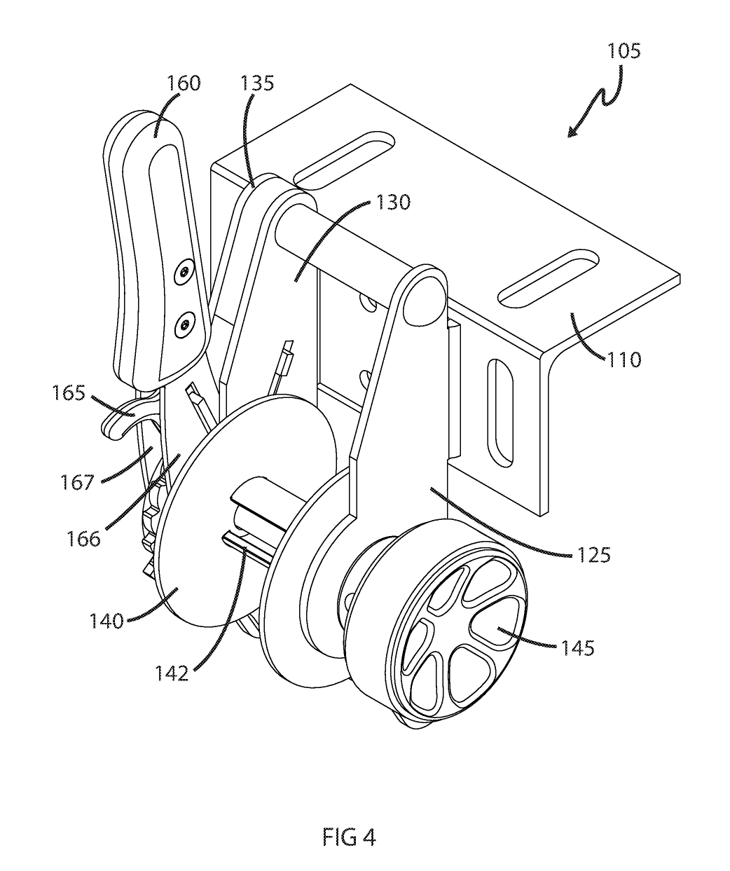

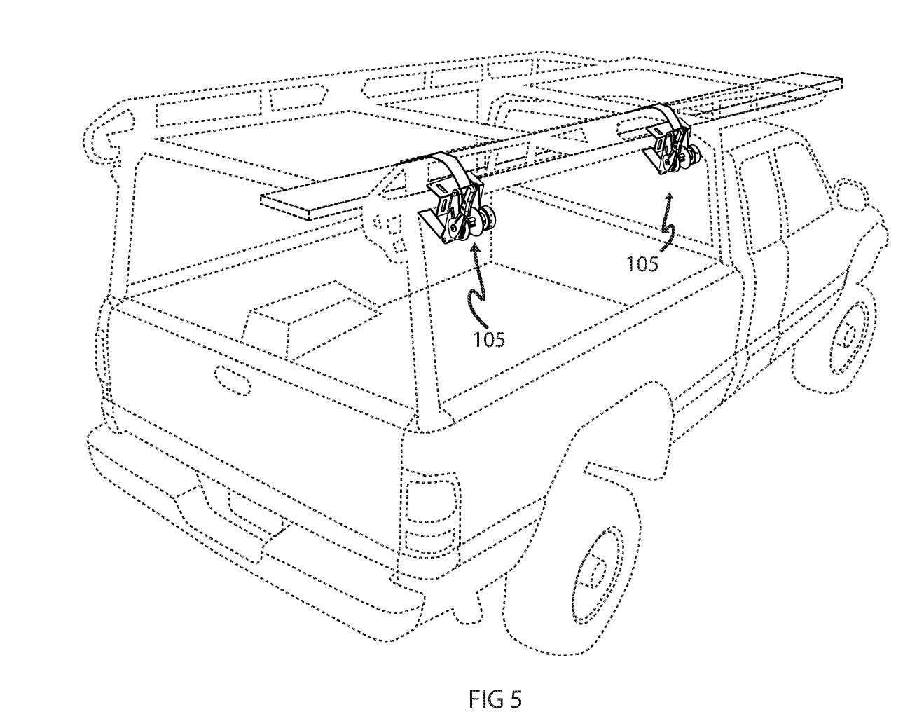

FIG. 3 shows a perspective view of a load tension assembly 105 with a strap 75 attached in accordance with one embodiment disclosed herein. FIG. 4 shows a perspective view of the load tension assembly of FIG. 3 with the strap removed in accordance with one embodiment disclosed herein. The load tension assembly 105 includes a mounting bracket 110, an L-bracket for example, for mounting the load tension assembly 105 to a surface or structure such as a rack, a beam, or similar type feature (see FIG. 5). The load tension assembly 105 further includes a plate 115 for attaching a main body 120 of the load tension assembly 105 to the mounting bracket 110.

The main body 120 of the load tension assembly 105 includes a rotatable hub 140 having a slot 142 to receive or accept a strap 75. The strap 75 typically includes a hook or similar device to anchor or secure one end of the strap 75 to a structure while the opposite end of the strap 75 is placed into the slot 142 (FIG. 4) of the rotatable hub 140. The rotatable hub 140 is disposed between a first side 125 and a second side 130. A rotatable knob 145 is attached to the rotatable hub 140 with the first side 125 positioned between the rotatable hub 140 and the rotatable knob 145. Positioned between the second side 130 and the third side 135, and attached to the rotatable hub 140 is a single gear 150. In this regard, the single gear 150 is positioned lateral to the rotatable hub 140. The rotatable hub 140 rotates to wrap the strap 75 about the rotatable hub 140 to apply tension to the strap 75 and a tension to a load when the strap is positioned around a load.

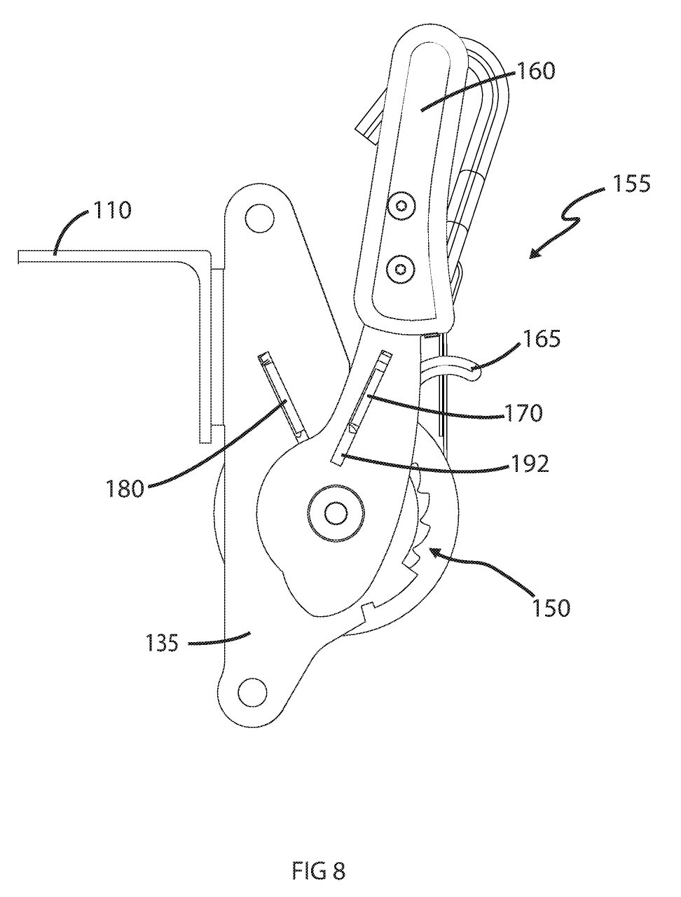

A handle assembly 155 having a grip 160 and trigger release 165 is attached to the main body 120 and configured to rotate the single gear 150 when the handle assembly 155 is moved in a direction relative to the main body 120 as shown in FIGS. 8-10. Movement of the handle assembly 155 and rotation of the single gear 150 and rotatable hub 140 provides a load tension to a load as the strap 75 is wrapped around the rotatable hub 140. As shown in FIG. 3 and FIG. 4, the entire handle assembly 155 is positioned lateral or to one side of the rotatable hub 140 and the strap 75 that is wrapped about the rotatable hub 140. By positioning the entire handle assembly 155 lateral of the rotatable hub, mechanical simplicity is achieved while the rotatable hub 140 and the strap 75 are unencumbered from any mechanical parts above or straddling of the strap 75 by the handle. In this regard, the amount of strap 75 wound or looped on the rotatable hub 140 is nearly unlimited, and the angle at which the strap 75 can be positioned relative to the rotatable hub 140 is unrestricted.

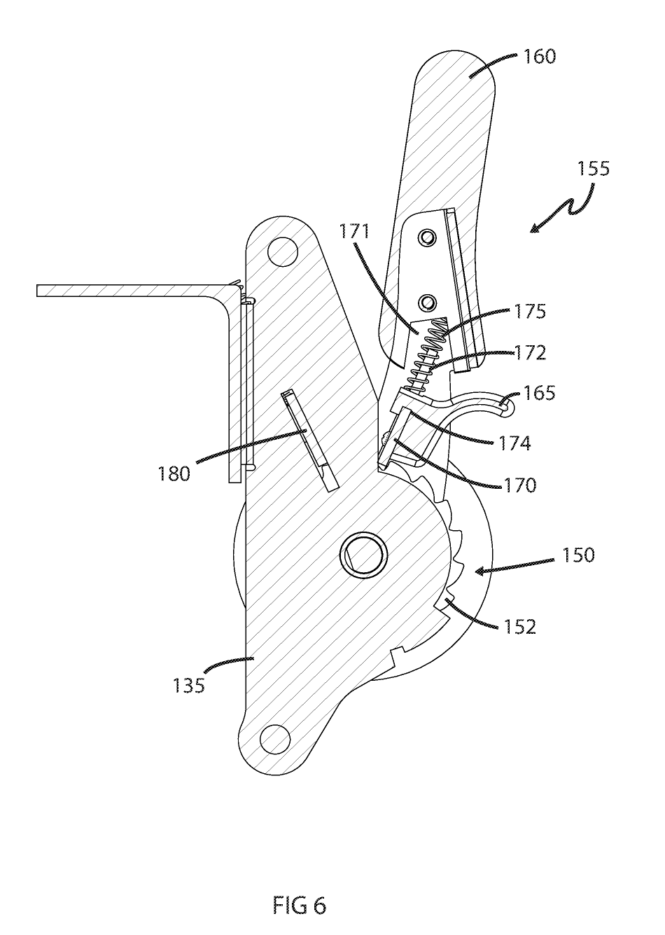

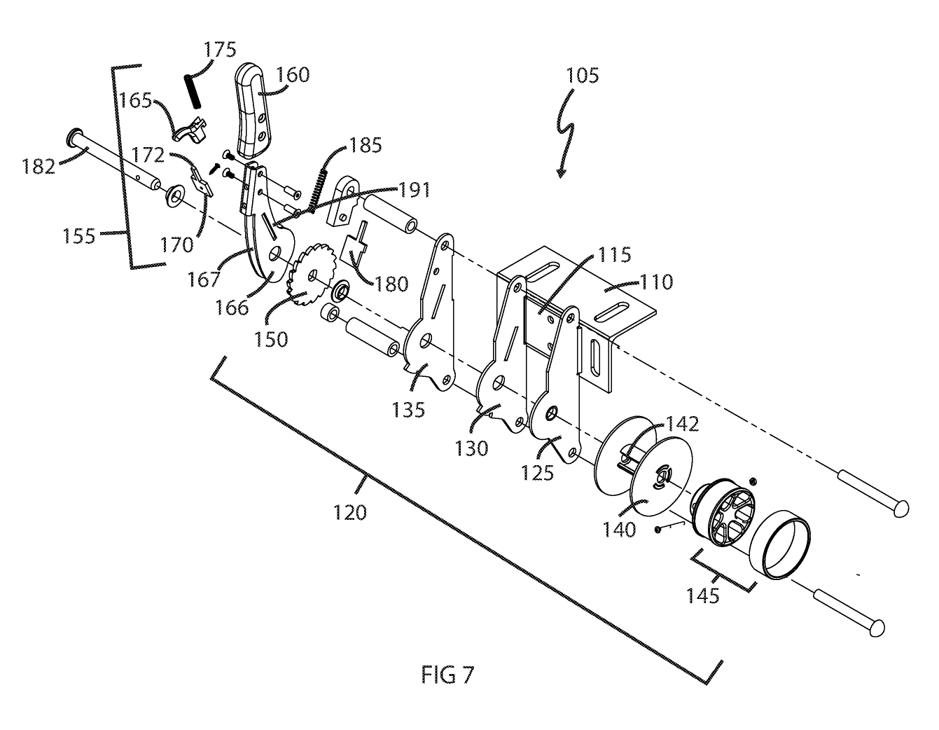

FIG. 6 shows a cut-away view of the handle assembly 155 of the load tension assembly 105 of FIG. 3 in accordance with one embodiment disclosed herein. The handle assembly 155 includes a first sidewall 166 and a second sidewall 167 spaced apart from each other at a first end to allow positioning of the first sidewall 166 and second sidewall 167 on opposite sides of the single gear 150. The trigger release 165 of the handle assembly 155 is position between the first sidewall 166 and the second sidewall 167, and includes a slotted groove 174 and an orifice to accept and connect to a drive pawl 170 having a top post 172. A first spring 175 is positioned on the top post 172 of the drive pawl 170 and is biased to force the drive pawl 170 to engage the teeth 152 of the gear 150.

The spaced apart first sidewall 166 and second sidewall 167 form a cavity 171 or space for positioning of the drive pawl 170, trigger release 165, and first spring therebetween. Each of the first sidewall 166 and second sidewall 167 include a corresponding sidewall slot 191, 192 for accepting the drive pawl 170 disposed between the first sidewall 166 and second sidewall 167. The first sidewall 166 and second sidewall 167 of the handle assembly 155 are elongated and of a sufficient length to provide improved leverage for ease of one hand operation. The first sidewall 166 and second sidewall 167 are connected to each other at a second end and are formed to receive the grip 160 to cover the second end. The grip 160 may be constructed of a durable material and curved to provide an ergonomic grip. In this regard, the grip 160 is ergonomically sized, shaped and constructed for comfort, proper hand placement, and improved leverage when grasping and moving the handle assembly 155.

The first side 125, the second side 130, the third side 135, the rotatable hub 140, and the knob 145 of the main body 120; and the single gear 150, the first sidewall 166, and the second sidewall 167 of the handle assembly 155 each have a orifice to receive a rod 182 that connects the aforementioned pieces in either a stationary (first side 125, second side 130, third side 135, first sidewall 166, and second sidewall 167) or a rotational position (single gear 150, rotatable hub 140, and knob 145) about the rod 182.

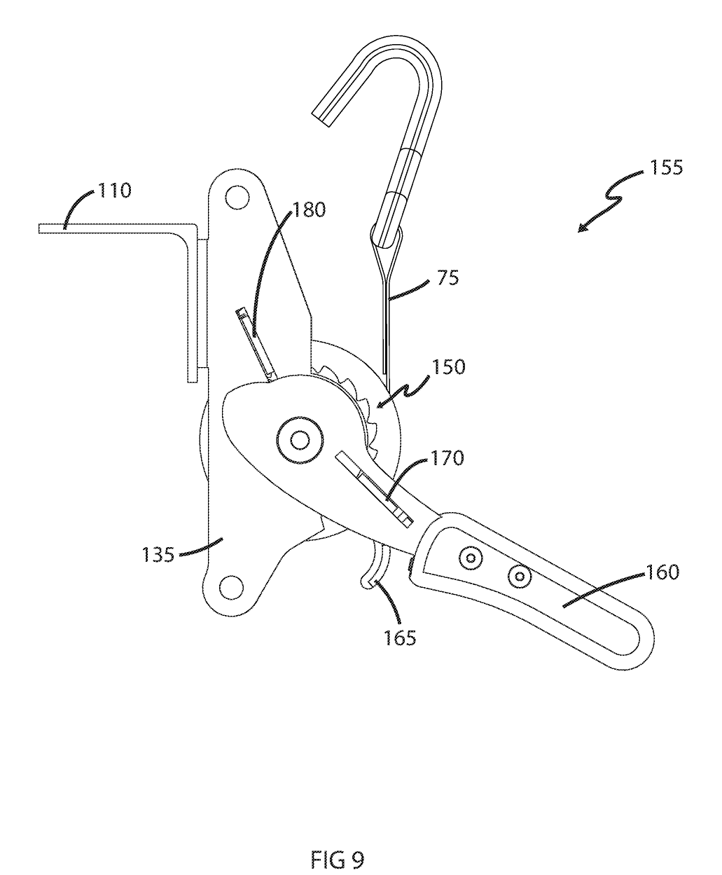

A stop pawl 180 is disposed within slots of the second side 130 and the third side 135 and is biased to engage the teeth 152 of the gear 150 by a second spring 185. As the handle assembly 155 is moved in a direction relative to the main body 120 as shown in FIGS. 8-10, the drive pawl 170 rotates the single gear 150 and tension is applied to the strap 75 as the strap 75 is wrapped around the rotatable hub 140. In this regard, the handle assembly 120 is moved along a load tension cycle from a first position shown in FIG. 8 to a second position shown in FIG. 9 to rotate the rotatable hub 140 and single gear 150 to a position of rotation and apply tension to the load. Those skilled in the art will understand that the first position and the second position of the handle assembly 155 as described herein are used for convenience and as examples for ease of disclosure, and that other positions are available throughout the range of movement or motion of the load tension cycle of the handle assembly 155.

As such, the load tension assembly 105 comprises a main body 120 including a rotatable hub 140 having a slot 142 to accept a strap 75 and a single gear 150 connected to the rotatable hub 140. The load tension assembly 105 further includes a handle assembly 155 having a drive pawl 170 biased by a first spring 175 to engage the single gear 150 of the main body 120, and a trigger release 165 connected to the drive pawl 170. The entire handle assembly 155 is positioned lateral to the rotatable hub 140. Movement of the handle assembly 155 rotates the single gear 150 and the rotatable hub 140 to a position of rotation to wrap the strap 75 about the rotatable hub 140 and apply tension to the strap 75.

Pressure is applied to the trigger release 165 to overcome the bias of the first spring 175 and raise the drive pawl 170 from engagement with the teeth 152 of the gear 150. With the drive pawl 170 in a raised position, the handle assembly 155 is moved relative to the main body 120 in the load tension cycle from the second position to the first position to incrementally move the drive pawl 170 over the individual teeth 152 of the single gear 150. As the drive pawl 170 is disengaged from the teeth 152 and moved over the teeth 152 of the single gear 150 the stop pawl 180 prevents the single gear 150 and the rotatable hub 140 from rotating in a direction opposite to the movement provided by the handle assembly 155 when moved from the first position to the second position. In this regard, the position of rotation of the rotatable hub 140 and the single gear 150 as a result of moving the handle assembly 155 from the first position to the second position is maintained. The process of moving the handle assembly 155 back-and-forth from the first position to the second and the second position to the first position within the load tension cycle repeats to tension the strap 75 and apply a load tension to a load.

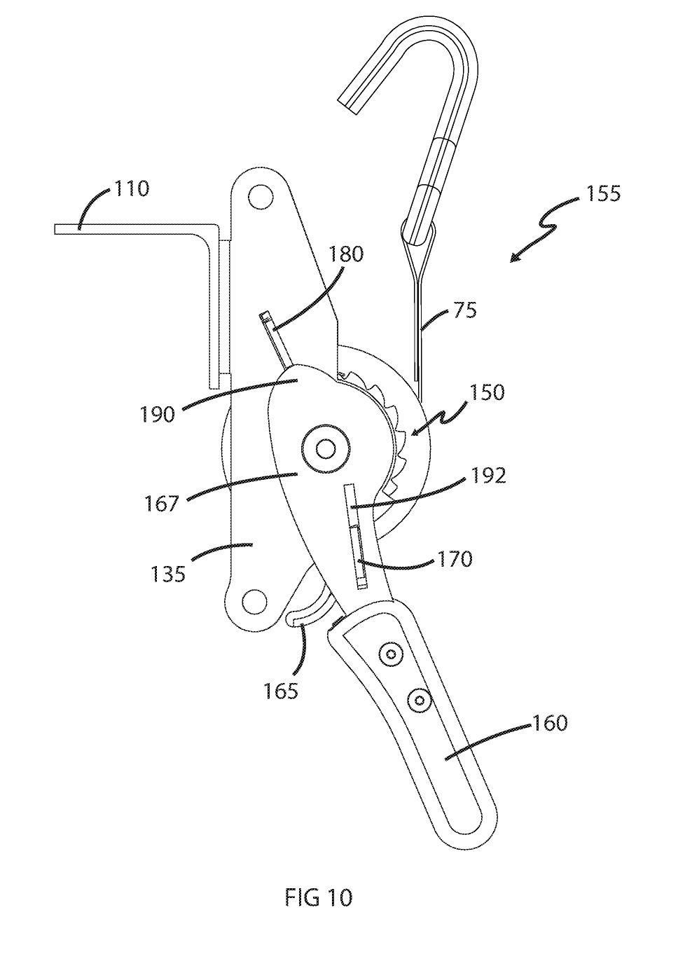

In order to release the tension to a load, the handle assembly 155 is moved to a third position within the load tension cycle, as shown in FIG. 10. The handle assembly 155 is shaped to include a protrusion 190 that contacts the stop pawl 180 and moves the stop pawl 180 away from the teeth 152 of the gear 150 to overcome the bias of the second spring 185 when the handle assembly 155 is in the third position. Placing the handle assembly 155 in the third position to disengage the stop pawl 180 from the teeth 152 of the single gear 150 in combination with applying pressure to the trigger release 165 to overcome the bias of first spring 175 and raise the drive pawl 170 allows the gear 150 and rotatable hub 140 to rotate freely resulting in the release of a load tension on the load. Maintaining pressure to the trigger release 165 permits the handle assembly 155 to be moved back to the first position.

Accordingly, the subject matter disclosed herein provides for among other things, a handle assembly having an ergonomic grip and trigger release for a relatively more efficient, versatile, and easier to use load tension assembly.

Although the method(s)/step(s) are illustrated and described herein as occurring in a certain order, the specific order, or any combination or interpretation of the order, is not required. Obvious modifications will make themselves apparent to those skilled in the art, all of which will not depart from the essence of the disclosed subject matter, and all such changes and modifications are intended to be encompassed within the appended claims.

What is claimed is:

1. A load tension assembly comprising:
a main body including a rotatable hub having a slot to accept a strap;
a single gear connected to the rotatable hub;
a stop pawl engaged with the single gear; and
a handle assembly having a drive pawl biased by a first spring to engage the single gear, and a trigger release connected to the drive pawl, the entire handle assembly and the stop pawl are each positioned lateral to the rotatable hub.

2. The load tension assembly of claim 1, wherein when the handle assembly is moved from a first position to a second position, the drive pawl rotates the single gear and the rotatable hub to a position of rotation to wrap the strap about the rotatable hub.

3. The load tension assembly of claim 2, wherein bias from the first spring is removed from the drive pawl to disengage the drive pawl from the single gear, the handle assembly is moved from the second position to the first position, and the position of rotation of the rotatable hub is maintained.

4. The load tension assembly of claim 3, wherein the stop pawl is biased by a second spring to engage the single gear and maintain the position of rotation of the rotational hub due to moving the handle assembly from the first position to the second position.

5. The load tension assembly of claim 4, wherein the handle assembly is structured to remove bias from the second spring on the stop pawl when the handle assembly is in a third position.

6. The load tension assembly of claim 1, wherein the handle assembly further includes a first sidewall and a second sidewall,
wherein the first sidewall and second sidewall are spaced apart and positioned on opposite sides of the single gear, and
wherein the first spring, the release trigger, and the drive pawl are positioned in a cavity formed between the first sidewall and the second sidewall, and the drive pawl is disposed in sidewall slots formed in each of the first sidewall and the second sidewall.

7. A load tension assembly comprising:
a main body including a rotatable hub;
a single gear connected to the rotatable hub;
a stop pawl engaged with the single gear; and
a handle assembly connected to the main body,.
wherein the handle assembly and the stop pawl are each positioned lateral to the rotatable hub, the handle assembly having a drive pawl engaged with the single gear, and a trigger release connected to the drive pawl.

8. The load tension assembly of claim 7, wherein when the handle assembly is moved from a first position to a second position, the drive pawl rotates the single gear and the rotatable hub to a position of rotation to wrap a strap positioned in a slot of the rotatable hub about the rotatable hub.

9. The load tension assembly of claim 8, wherein when the drive pawl is disengaged from the single gear and the handle assembly is moved from the second position to the first position, the position of rotation of the rotatable hub is maintained.

10. The load tension assembly of claim 9, further including a stop pawl biased by a second spring to engage the single gear and maintain the position of rotation of the rotational hub due to moving the handle assembly from the first position to the second position.

11. The load tension assembly of claim 10, wherein the handle assembly is structured to remove the bias from the stop pawl when the handle assembly is in a third position.

12. The load tension assembly of claim 7, further including a first spring connected to the drive pawl to bias the drive pawl to engage the single gear.

13. The load tension assembly of claim 12, wherein the handle assembly further includes a first sidewall and a second sidewall,
wherein the first sidewall and second sidewall are spaced apart and positioned on opposite sides of the single gear, and
wherein the first spring, the release trigger, and the drive pawl are positioned in a cavity formed between the first sidewall and the second sidewall, and the drive pawl is disposed in sidewall slots formed in each of the first sidewall and the second sidewall.

14. A load tension assembly comprising:
a main body including a rotatable hub;
a single gear connected to the rotatable hub;
a stop pawl engaged with the single gear; and
a handle assembly having a drive pawl engage with the single gear,
wherein the entire handle assembly and the stop pawl are each positioned lateral to the rotatable hub.
